(19) United States
(12) Patent Application Publication
(10) Pub. No.: US 2008/0014515 A1
(43) Pub. Date: Jan. 17, 2008

(54) Organic photoreceptor and electrophotographic image forming apparatus including the organic photoreceptor

(75) Inventors: Saburo Yokota, Suwon-si (KR); Moto Makino, Suwon-si (KR); Hwan-koo Lee, Suwon-si (KR); Beom-jun Kim, Yongin-si (KR); Seung-ju Kim, Suwon-si (KR); Ji-Young Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/606,220

(22) Filed: Nov. 30, 2006

(30) Foreign Application Priority Data
Jul. 11, 2006 (KR) 10-2006-0064972

(51) Int. Cl. G03G 5/06

(52) U.S. Cl. 430/56; 430/133

(57) ABSTRACT

An organic photoreceptor and an electrophotographic image forming apparatus provided including the organic photoreceptor, wherein the organic photoreceptor has the shortage of a conventional single-layered type photoreceptor and has higher photosensitivity and good repetition stability. The photoreceptor has a photosensitive layer on an electrically conductive substrate where the photosensitive layer has an electron transporting material that increases in concentration toward the interface between the substrate and the photosensitive layer.

### CROSS-REFERENCE TO RELATED PATENT APPLICATION

This application claims the benefit under 35 U.S.C. §119(a) of Korean Patent Application No. 10-2006-0064972, filed on Jul. 11, 2006, in the Korean Intellectual Property Office, the disclosure of which is hereby incorporated by reference in its entirety.

### BACKGROUND OF THE INVENTION

1. Field of the Invention

The present invention relates to an organic photoreceptor and an electrophotographic image forming apparatus including the organic photoreceptor. More particularly, the invention is directed to an organic photoreceptor having the same advantages as a conventional single-layered photoreceptor and having higher photosensitivity and excellent stability when used repeatedly. The invention is further directed to an electrophotographic image forming apparatus including the organic photoreceptor.

2. Description of the Related Art

In general, an electrophotographic photoreceptor comprises an electrically conductive substrate and a photosensitive layer formed on the electrically conductive substrate of a charge generating material, a charge transporting material, a binder resin, and so forth. The photosensitive layer is usually a laminated photoreceptor with separated functions, which has been conventionally obtained by laminating a charge generating layer and a charge transporting layer.

Meanwhile, a single-layered photoreceptor, which can be produced using a simple manufacturing process, has been used in the fabrication of a positive (+) type electrophotographic photoreceptor. The (+) type electrophotographic photoreceptor has the advantage in that it can be used with (+) type corona charging and generates a small amount of ozone that is harmful to humans.

Examples of the conventional single-layered electrophotographic photoreceptor include the photoreceptor disclosed in U.S. Pat. No. 3,484,237, which is formed of a PVK/TNF charge moving complex. The photoreceptor disclosed in U.S. Pat. No. 3,397,086 includes a resin in which a photoconductive phthalocyanine is dispersed. The photoreceptor disclosed in U.S. Pat. No. 3,615,414 includes a resin in which aggregates of thiopyrylium and polycarbonate are dispersed with a charge transporting material. However, such photoreceptors do not have sufficient electrostatic properties, and the materials for manufacturing them are difficult to select and also may be harmful. Thus, most of these photoreceptors are not used at this time.

The single-layered photoreceptors that have been mainly developed recently include a resin in which a charge generating material is dispersed with a hole transporting material and an electron transporting material. Since the functions of charge generation and charge transportation of the single-layered photoreceptors are separated, the materials for manufacturing them can be selected from a wide range of materials. Also, the concentration of the charge generating material can be set to be low to improve the mechanical and chemical durability of the photosensitive layer. However, the single-layered photoreceptor has substantial disadvantages such as high residual current and low repetition stability. These disadvantages may be because charges are generated in a charge generating material which is uniformly dispersed in the photosensitive layer, and thus injection and transportation of holes and electrons have to be performed efficiently and simultaneously, and particularly, because electrons having low mobility are likely to remain in the low electric field where transportation efficiency is lowered.

### SUMMARY OF THE INVENTION

The present invention provides an organic photoreceptor having the same advantages as a conventional single-layered photoreceptor and having improved electric properties.

The present invention also provides an electrophotographic image forming apparatus, an electrophotographic cartridge, and an electrophotographic drum including the organic photoreceptor.

According to an aspect of the present invention, an organic photoreceptor comprises: an electrically conductive substrate; and a photosensitive layer that is formed on the electrically conductive substrate and includes a charge generating material, a charge transporting material, and a binder resin, wherein the charge transporting material includes an electron transporting material, and a concentration of the electron transporting material increases in a direction toward an interface near the electrically conductive substrate.

According to another aspect of the present invention, an image forming apparatus includes an organic photoreceptor comprising: an electrically conductive substrate; and a photosensitive layer that is formed on the electrically conductive substrate and includes a charge generating material, a charge transporting material, and a binder resin, wherein the charge transporting material includes an electron transporting material, and a concentration of the electron transporting material increases in a direction toward an interface near the electrically conductive substrate.

According to another aspect of the present invention, an electrophotographic cartridge comprises: an organic photoreceptor comprising: an electrically conductive substrate; and a photosensitive layer that is formed on the electrically conductive substrate and includes a charge generating material, a charge transporting material, and a binder resin, wherein the charge transporting material includes an electron transporting material, and a concentration of the electron transporting material increases in a direction toward an interface near the electrically conductive substrate;

a charging device for charging the electrophotographic photoreceptor;

a developing device for developing an electrostatic latent image formed on the electrophotographic photoreceptor;

a cleaning device for cleaning a surface of the electrophotographic photoreceptor,

wherein the electrophotographic cartridge is attachable to or detachable from an imaging apparatus.

According to another aspect of the present invention, an electrophotographic drum including an organic photoreceptor comprising: an electrically conductive substrate; and a photosensitive layer that is formed on the electrically conductive substrate and includes a charge generating material, a charge transporting material, and a binder resin, wherein the charge transporting material includes an electron transporting material, and a concentration of the electron transporting material increases in a direction toward an interface near the electrically conductive substrate,

wherein the electrophotographic drum is attachable to or detachable from an imaging apparatus.

According to another aspect of the present invention, an image forming apparatus comprises:

a photoreceptor unit comprising an organic photoreceptor comprising: an electrically conductive substrate; and a photosensitive layer that is formed on the electrically conductive substrate and includes a charge generating material, a charge transporting material, and a binder resin, wherein the charge transporting material includes an electron transporting material, and a concentration of the electron transporting material increases in a direction toward an interface near the electrically conductive substrate;

a charging device for charging the photoreceptor unit;

an imagewise light irradiating device for irradiating light onto the charged photoreceptor unit to form an electrostatic latent image on the photoreceptor unit;

a developing unit for developing the electrostatic latent image with a toner to form a toner image on the photoreceptor unit; and

a transfer device for transferring the toner image onto a receptor.

These and other aspects of the invention will become apparent from the following detailed description of the invention which disclose various embodiments of the invention.

### BRIEF DESCRIPTION OF THE DRAWING

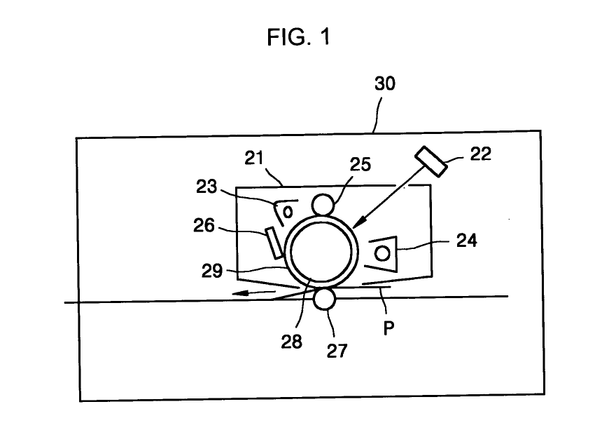

The above and other features and advantages of the present invention will become more apparent by describing in detail exemplary embodiments thereof with reference to FIG. 1 illustrating an image forming apparatus, an electrophotographic drum, and an electrophotographic cartridge according to an embodiment of the present invention.

### DETAILED DESCRIPTION OF THE INVENTION

The present invention will now be described more fully with reference to the accompanying drawings, in which exemplary embodiments of the invention are shown.

The present invention provides an organic photoreceptor comprising an electrically conductive substrate layer and a photosensitive layer which is formed on the electrically conductive substrate and includes a charge generating material, a charge transporting material, and a binder resin in a single layer. The charge transporting material includes an electron transporting material, where the concentration of the electron transporting material increases in the direction from the external surface of the photosensitive layer to an interface near the electrically conductive substrate. In other words, in the photosensitive layer, more electron transporting material is contained around the interface near the electrically conductive substrate than in other portions of the photosensitive layer.

In the above described configuration, the organic photoreceptor has higher photosensitivity and better repetition stability

The factors that make the organic photoreceptor of the present invention outstanding are as follows. The inventors found through much effort and research that charges are generated on the surface of the photosensitive layer and at the interface between the photosensitive layer and the electrically conductive substrate in a photoreceptor in which a charge generating material, a charge transporting material, and a binder resin are contained in a single photosensitive layer. In other words, light energy absorbed inside the photosensitive layer does not immediately generate charges but is transmitted through the inside and starts to generate charges when it has reached the surface and the interface.

In a positive charged photoreceptor, holes caused by charge generation on the surface of the photosensitive layer are transported to the electrically conductive substrate. When charges are generated at the interface between the electrically conductive substrate and the photosensitive layer, on the other hand, charges are transported to the surface of the photosensitive layer. That is, a hole transporting material is related to charge generation on the surface of the photosensitive layer, and an electron transporting material is greatly involved in charge generation at the interface between the photosensitive layer and the electrically conductive layer.

However, the electron mobility of an electron transporting material used as a photoreceptor is very small in relation to hole mobility of a hole transporting material, and thus charge generation at the interface of the electrically conductive substrate interrupts smooth transportation of electrons having small mobility. Electrons that cannot be transported are likely to disappear, for example, due to rebonding with holes, and thus efficiency is deteriorated. As a result, in a conventional photoreceptor where a hole transporting material and an electron transporting material are distributed with a uniform concentration, charges are generated mainly at the surface of the photosensitive layer, and most of the energy that has reached the interface of the electrically conductive substrate is lost as heat.

In the electrophotographic photoreceptor of the present invention, since an electron transporting material is present at high concentration at the interface between electrically conductive substrate and the photosensitive layer, separation and transportation of electrons are easy, and thus charge generation on the surface of the photosensitive layer and at the interface of the substrate becomes efficient and energy loss is small, thereby obtaining high photosensitivity. Also, accumulation of electron trap at the interface of the substrate which deteriorates the electrical properties of the photoreceptor is prevented, thereby improving the repetition stability.

The electrically conductive substrate used in the electrophotographic photoreceptor of the present invention may be made of metal, such as aluminum, aluminum alloy, stainless copper, copper, nickel, and others. Also, the electrically conductive substrate may be an insulating substrate such as a polyester film, paper, glass, and the like, coated with a conductive layer such as aluminum, copper, palladium, tin oxide, indium oxide, and the like, on a surface of the substrate. An anodized oxidization thin film using sulfide solution, oxalate, and the like, or a binder resin such as polyamide, polyurethane, epoxy resin, and the like, may be coated between the electrically conductive substrate and the photosensitive layer.

The main characteristic of the organic photoreceptor according to the present invention is that more electron transporting material is contained at the interface near the electrically conductive substrate than other portions of the photoreceptor layer. The above configuration can be realized by first providing an electron transporting material alone or an electron transporting material layer formed of a resin distribution layer on an electrically conductive substrate, and then coating a solution for forming a photosensitive layer including a solvent that can dissolve the electron transporting material layer. In other words, a portion of or the whole electron transporting material in the lower portion is dissolved while the upper layer is coated and dried and is mixed with the components of the upper layer. Thus, the electron transporting material is contained at a higher concentration around the interface between the electrically conductive substrate and the photosensitive layer.

The electron transporting material layer can be formed by applying an electron transporting material alone using liquid-coating, vacuum-deposition, sputtering, or a CVD method, or by liquid-coating an electron transporting material with a binder to increase the adhesive force or the intensity of a film. When used with a binder resin, the electron transporting material should be in a high concentration of at least about 30 weight %, preferably about 40 to 80 weight %.

The thickness of the electron transporting material layer may be about 0.01 to about 1 μm.

Examples of the electron transporting material include electron absorbing low molecular weight compounds or electron transporting polymer compounds such as benzoquinone, tetracyanoethylene, tetracyanoquinodimethane, fluorenone, xanthone, penantraquinone, phthalic anhydride, diphenoquinone, stilbene quinone, naphthalene, thiopyran, and the like, but are not limited thereto.

The binder resin may be a polymer capable of forming an electrically insulating film. Also, to increase the affinity to a photosensitive layer to be formed thereon, the binder resin may be the same resin for forming the upper layer. Examples of the polymer include polycarbonate, polyester, methacrylic resin, acrylic resin, polyvinyl chloride, polyvinylidene chloride, polystyrene, polyvinylacetate, styrene-butadiene copolymer, vinylidene chloride-acrylonitrile copolymer, vinyl chloride-vinyl acetate copolymer, vinyl chloride-vinyl acetate-maleic anhydride copolymer, silicone resin, silicone-alkyd resin, phenol-formaldehyde resin, styrene-alkyd resin, poly-N-vinyl carbazole, polyvinyl butyral, polyvinyl formal, polysulfone, casein, gelatin, polyvinyl alcohol, ethyl cellulose, phenol resin, polyamide, carboxymethyl cellulose, vinylidene chloride-based polymer latex, polyurethane, and the like, but are not limited thereto. The binder resin may be used alone or in combination of at least two materials.

The upper layer can be coated using a conventional liquid coating method. When the upper layer is coated using a conventional dipping method, a lower layer is likely to be eluted, and thus the dipping solution may be polluted. To prevent such pollution, a spray coating method, a ring coating method, a roll coating method, and the like, may be used.

The upper layer to be coated on the electron transporting material layer can be obtained by dispersing a charge generating material together with a binder resin and a charge transporting material in a solvent and coating the mixed solution.

Examples of the charge generating material used in a photoconductive layer include organic pigments such as an azo pigment, a quinone pigment, a perylene pigment, an indigo pigment, a thioindigo pigment, a bisbenzoimidazole pigment, a phthalocyanine pigment, a quinacridone pigment, a quinoline pigment, a lake pigment, an azolake pigment, an anthraquinone pigment, an oxazine pigment, a dioxazine pigment, a triphenyl methane pigment, an azulenium pigment, a squarium pigment, a prylium pigment, a trialyl methane pigment, a xanthene pigment, a thiazine pigment, a cyanine pigment, and the like, or inorganic pigments such as amorphous silicone, amorphous selenium, telulium, selenium-telenium alloy, cadmium sulfide, antimone sulfide, zinc oxide, zinc sulfide, and the like. The charge generating material may be used alone or in combination of at least two materials. The charge transporting material can include a hole transporting material and an electron transporting material, and the photoreceptor according to the present invention contains a hole transporting material as an essential component.

Examples of the hole transporting material include low molecular weight compounds such as pyrene, carbazole, hydrazone, oxazole, oxadiazole, pyrazoline, arylaamine, arylmethane, benzidine, thiazol, stilbene, or butadiene compounds and high molecular weight compounds such as poly-N-vinyl carbazole, halogenated poly-N-vinyl carbazole, polyvinyl pyrene, polyvinyl anthracene, polyvinyl acridine, pyrene formaldehyde resin, ethyl carbazole formaldehyde resin, triphenylmethane polymer, or polysilane.

The hole transporting material that can be used in the electrophotographic photoreceptor according to the present invention is not limited to the above examples and may be used alone or in combination of at least two materials. When necessary, the electron transporting material may be mixed with the hole transporting material.

The electron transporting material may be not only a material that can be used as the lower layer but also an inorganic material having an electron transporting ability or a pigment having an electron transporting ability. Examples of the electron transporting material may be known materials in the field and include a benzoquinone compound, a naphthoquinone compound, an anthraquinone compound, a malononitrile compound, a fluorenone compound, a dicyanofluorenone compound, a benzoquinoneimine compound, a diphenoquinone compound, a stilbene quinone compound, a diiminoquinone compound, a dioxotetracenedione compound, a thiopyran compound, and the like. However, the charge transporting material used in the present invention is not limited to the hole transporting material or the electron transporting material, and may be other material besides the known materials, and may be used in combination of at least two materials.

Resins that can be used for the lower layer may also be used for the upper layer. The binder resin used for the upper layer may be the same as or different from the resin used for the lower layer.

The content of the charge transporting material in the photosensitive layer may be about 10 to about 60 weight % with respect to the total weight of the photosensitive layer. When the content of the charge transporting material is less than 10 weight %, the charge transporting ability is insufficient and the residual potential increases. When the content of the charge transporting material is greater than 60 weight %, the amount of the resin is reduced, and thus, the mechanical intensity is decreased.

The total thickness of the photosensitive layer is generally set within the range from about 5 to about 50 μm.

Additives such as a dispersion stabilizer, a plasticizer, a surface modifier, an antioxidant, a photodeterioration inhibitor, and others also may be used together with the binding resin.

Examples of the plasticizer include biphenyl, chlorinated biphenyl, terphenyl, dibutyl phthalate, diethylene glycol phthalate, dioctylphthalate, triphenyl phosphite, methyl naphthalene, benzophenone, chlorinated paraffin, polypropylene, polystyrene, and all kinds of fluorine hydrocarbon.

Examples of the surface modifier are silicon oil, fluorine resin, and the like.

Examples of the antioxidant include phenol, sulfur, phosphor, amine compounds, and the like. Examples of the phenol-based antioxidant include 2,6-di-tert-butylphenol, 2,6-di-tert-butyl-4-methoxyphenol,2,6-di-tert-butyl-4-methyl phenol, 2-tert-butyl-4-methoxyphenol,2,4-dimethyl-6-tert-butylphenol,2-tert-butylphenol,3,6-di-tert-butylphenol, 2,4-di-tert-butylphenol,2,6-di-tert-butyl-4-ethylphenol, 2-tert-butyl-4,6-methyl phenol,2,4,6-tert-butylphenol,2,6-di-tert-butyl-4-stearyl propionate phenol, α-tocopherol, β-tocopherol, γ-tocopherol, naphtol AS, naphtol AS-D, naphtol AS-BO, 4,4′-methylenebis (2,6-di-tert-butylphenol),4,4′-methylenebis (6-tert-butyl-4-methyl phenol), 2,2′-methylenebis (4-methyl-6-tert-butylphenol),2,2′-methylenebis (4-ethyl-6-tert-butylphenol),2,2′-ethylene bis (4,6-di-tert-butylphenol),2,2′-propylene bis (4,6-di-tert-butylphenol),2,2′-butane bis (4,6-di-tert-butylphenol),2,2′-ethylene bis (6-tert-butyl-m-cresol),4,4′-butane bis (6-tert-butyl-m-cresol),2,2′-butane bis ((6-tert-butyl-p-cresol),2,2′-thiobis ((6-tert-butylphenol),4,4′-thiobis (6-tert-butyl-m-cresol), 4,4′-thiobis (6-tert-o-cresol),2,2′-thiobis (4-methyl-6-tert-butylphenol), 1,3,5-trimethyl-2,4,6-tris (3,5-di-tert-butyl-4-hydroxybenzyl) benzene, 1,3,5-trimethyl-2,4,6-tris (3,5-di-tert-amyl-4-hydroxybenzyl) benzene, 1,3,5-trimethyl-2,4,6-tris (3-tert-butyl-5-methyl-4-hydroxybenzyl) benzene, 2-tert-butyl-5-methyl-phenyl amine phenol,4,4′-bis amino (2-tert-butyl-4-methyl phenol), n-octadecyl-3-(3′,5′-di-tert-butyl -4′-hydroxyphenyl) propionate, 2,2,4-trimethyl-6-hydroxy-7-tert-butyl chroman, tetrakis (methylene-3 (3,5-di-tert-butyl-4-hydroxyphenyl) propionate) methane,1,1,3-tris (2-methyl-4-hydroxy-5-tert-butylphenyl) butane, and the like, but are not limited thereto.

Examples of the phosphor antioxidant include tri(2,4-di-t-butyl phenyl)phosphite, bis(2,4-di-t-butylphenyl)pentaerythritol diphosphite, bis(2,4-di-dicumylphenyl) pentaerythritol disphosphite, tri(4-n-noylphenyl)phosphite or tetrakis(2,4-di-tert-butyl-phenyl)4,4′-biphenylene-diphosphite, and combinations of these, but are not limited thereto.

Examples of the photodeterioration inhibitor include a benzotriazole-based compound, a benzophenone-based compound, a hindered amine-based compound, and the like.

The solvent for the solution may vary according to the kind of the binder resin and an optimum solvent may be selected. Examples of the organic solvent include: alcohols, such as methanol, ethanol, and n-propanol; ketones such as acetone, methylethyl ketone, and cyclohexanone; amides such as N,N-dimethyl formamide and N,N-dimethyl acetamide; ethers, such as tetrahydrofaran, dioxane, methyl cellosolve, and the like; esters, such as methyl acetate, ethyl acetate, and the like; sulfoxides and sulfones such as dimethylsulfoxide, sulforane; halogenated aliphatic hydrocarbons such as chloride methylene, chloroform, carbon tetrachloride, and trichloroethane; and aromatic hydrocarbons, such as benzene, toluene, xylene, monochlorobenzene, dichlorobenzene, and the like. Also, a functional layer such as an intermediate layer or a surface protecting layer may be further included in the organic photoreceptor of the present invention when necessary.

An electrophotographic imaging apparatus, an electrophotographic photoreceptor drum, and an electrophotographic cartridge using the electrophotographic photoreceptor according to the present invention will now be described in detail.

FIG. 1 schematically illustrates an image forming apparatus 30 including an electrophotographic photoreceptor drum 28 and an electrophotographic cartridge 21 according to an embodiment of the present invention. The electrophotographic cartridge 21 typically includes an electrophotographic photoreceptor 29, one or more charging devices 25 for charging the electrophotographic photoreceptor 29, a developing device 24 for developing an electrostatic latent image formed on the electrophotographic photoreceptor 29, and a cleaning device 26 for cleaning a surface of the electrophotographic photoreceptor 29. The electrophotographic cartridge 21 can be attached to and detached from the image forming apparatus 30.

The electrophotographic photoreceptor drum 28 of the image forming apparatus 30 can generally be attached to and detached from the image forming apparatus 30 and includes the electrophotographic photoreceptor 29.

Generally, the image forming apparatus 30 includes a photosensitive unit (formed, for example, as the drum 28 and the electrophotographic photoreceptor 29); the charging device 25 for charging the photoreceptor unit; an imagewise light irradiating device 22 for irradiating light onto the charged photoreceptor unit to form an electrostatic latent image on the photoreceptor unit; the developing unit 24 for developing the electrostatic latent image with a toner to form a toner image on the photoreceptor unit; and a transfer device 27 for transferring the toner image onto a receiving material, such as paper P. The photoreceptor unit includes the electrophotographic photoreceptor 29, which will be described below. The charging device 25 may be supplied with a voltage as a charging unit and may charge the electrophotographic photoreceptor 29. The image forming apparatus 30 may also include a pre-exposure unit 23 to erase residual charges from the surface of the electrophotographic photoreceptor 29 for a next printing cycle.

The organic photoreceptor according to an embodiment of the present invention can be integrated into electrophotographic image forming apparatuses such as laser printers, photocopiers, and facsimile machines.

Hereinafter, the present invention will be described in detail with reference to the following examples. However, these examples are for illustrative purposes only and are not intended to limit the scope of the invention. In addition, the term “part” throughout the description of the examples refers to “parts by weight”.

### EXAMPLE 1

A coating solution is obtained by dissolving 5 parts of an electron transporting material of Formula 1 below in 96 parts of chloroform was applied on an aluminum drum defining a substrate having a diameter of 30 mm in order to form an electron transporting material layer having a thickness of 0.1 μm.

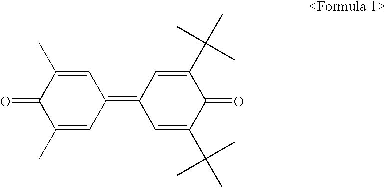

A dispersion solution was prepared from 3 parts of X-type nonmetal phthalocyanine uniformly dispersed in a solution containing 60 parts of polycarbonate Z resin (lupilon Z-200, available from Mitsubishi Gas Chemicals) and 40 parts of a hole transporting material represented by Formula 2 below 300 parts of chloroform. The dispersion solution was coated on the electron transporting material layer by a ring coating method and dried at 100° C. for 1 hour to obtain an electrophotographic photoreceptor. A portion of the photoreceptor was exfoliated and a cross-section of the portion was observed using a microscope. As a result, coloring due to elution of the electron transporting material layer of the lower layer was observed to be in a range about 2 μm away from the substrate defined by the aluminum drum, which indicates that a region where the electron transporting material is contained at high concentration is formed around the interface of the substrate and the resulting photoconductive layer.

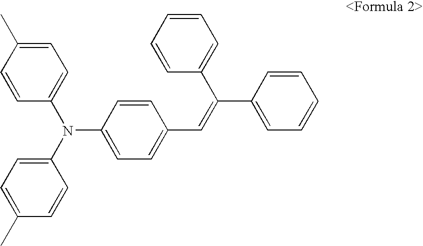

### EXAMPLE 2

An electrophotographic photoreceptor was obtained in the same manner as in Example 1, except that an electron transporting material layer was formed to have a thickness of 0.2 μm using a solution of 3 parts of an electron transporting material of Formula 1 and 2 parts of the polycarbonate Z resin used in the upper layer, dissolved in 95 parts of chloroform, instead of the solution for forming the electron transporting material layer of Example 1.

### EXAMPLE 3

An electrophotographic photoreceptor was obtained in the same manner as in Example 1, except that a photosensitive layer was formed to a thickness of 20 μm using a dispersion solution in which 3 parts of nonmetal phthalocyanine, 55 parts of polycarbonate Z resin (lupilon Z-200), available from Mitsubishi Gas Chemicals), 10 parts of an electron transporting material of Formula 1, and 35 parts of Formula 2 were dissolved in 300 parts of chloroform, instead of the solution for forming the upper layer of Example 1.

### COMPARATIVE EXAMPLE 1

An electrophotographic photoreceptor was obtained in the same manner as in Example 1, except that no electron transporting material layer was included.

### COMPARATIVE EXAMPLE 2

An electrophotographic photoreceptor was obtained in the same manner as in Example 3, except that no electron transporting material layer was included.

Electrophotographic Properties

The electrophotographic properties of each photoreceptor were measured using a drum photoreceptor evaluation apparatus (PDT-2000, available from QEA) at 23° C., at a humidity of 50%.

The measurement conditions were as follows. A corona voltage of 7 kV was applied to the electrophotographic photosensitive drum at a relative speed of the charging device and the photoreceptor of 100 mm/sec. Immediately, a monochromatic light having a wavelength of 780 nm was radiated onto the surface of the electrophotographic photosensitive drum at an exposure intensity of 10 mW/m² for 5 seconds and variation in the surface potential values of the photosensitive drum was recorded. Here, the surface potential before radiating light is referred to as V₀[V], and the surface potential after 5 seconds of light radiation is referred to as Vᵢ[V]. In addition, the radiation energy obtained from the time needed for V₀ to be attenuated to half is referred to as E_{1/2}[mJ/m²]. Then, a series of processes as charging, post-exposure, and radiating an antistatic light at a wavelength of 660 nm, having an exposure energy of 50 mJ/m² were repeated 100 times and then the electric properties of the photoreceptor were recorded and variation from the initial state was examined to evaluate the repetition stability. The results are listed in Table 1.

TABLE 1

| Photoreceptor | State | V₀ [V] | Vᵢ [V] | E_{1/2} [mJ/m²] |
|---|---|---|---|---|
| Example 1 | Before | 682 | 49 | 3.91 |
| | After | 655 | 82 | 4.47 |
| Example 2 | Before | 703 | 52 | 4.02 |
| | After | 652 | 89 | 4.58 |
| Comparative | Before | 678 | 50 | 5.22 |
| Example 1 | After | 597 | 113 | 6.17 |
| Example 3 | Before | 678 | 26 | 3.87 |
| | After | 675 | 34 | 3.91 |
| Comparative | Before | 676 | 28 | 4.37 |
| Example 2 | After | 671 | 39 | 4.44 |

In Examples 1 and 2, and Comparative Example 1, an electron transporting material was not contained on the surface of the photosensitive layer where charges are generated mainly. Thus, electrons generated around the surface of the photosensitive layer cannot move and thus the residual current was high. However, the photosensitivity of the photoreceptor of Examples 1 and 2 is significantly increased compared to the photosensitivity of the photoreceptor of Comparative Example 1. Also, when comparing the photoreceptors of Example 3 and Comparative Example 2 containing en electron transporting material in the upper layer, the photosensitivity of the photoreceptor of Example 3 was obviously higher, and the repetition stability thereof was better.

As evident from the results above, the photoreceptor according to the present ion has the same advantages as a conventional single-layered photoreceptor but has photosensitivity and good repetition stability.

While the present invention has been particularly shown and described with nce to exemplary embodiments thereof, it will be understood by those of ordinary skill art that various changes in form and details may be made therein without departing he spirit and scope of the present invention as defined by the following claims.

What is claimed is:

1. An organic photoreceptor comprising:
an electrically conductive substrate; and
a photosensitive layer that is formed on the electrically conductive substrate and includes a charge generating material, a charge transporting material, and a binder resin,
wherein the charge transporting material includes an electron transporting material, and where a concentration of the electron transporting material increases in a direction toward an interface near the electrically conductive substrate.

2. The organic photoreceptor of claim 1, wherein the photosensitive layer is formed by forming an electron transporting material layer containing an electron transporting material on the electrically conductive layer, and then coating a solution for forming a photosensitive layer including a solvent that can dissolve the electron transporting material layer.

3. The organic photoreceptor of claim 2, wherein a thickness of the electron transporting material layer is about 0.01 to about 1 μm.

4. The organic photoreceptor of claim 2, wherein the solution for forming the photosensitive layer includes a charge generating material, a charge transporting material, a binder, and a solvent that can dissolve the electron transporting material layer.

5. The organic photoreceptor of claim 2, wherein the solution for forming the photosensitive layer is coated by a method selected from the group consisting of a ring coating method, a spray coating method, and a roll coating method.

6. The organic photoreceptor of claim 1, wherein the photosensitive layer is formed by forming a layer containing an electron transporting material dispersed by a binder on the electrically conductive substrate, and then coating a solution for forming the photosensitive layer on the layer containing the electron transporting material.

7. The organic photoreceptor of claim 6, wherein the content of the electron transporting material in the electron transporting material layer is 30 weight % or greater.

8. The organic photoreceptor of claim 6, wherein a thickness of the electron transporting material layer is from about 0.01 to about 1 μtm.

9. The organic photoreceptor of claim 6, wherein the solution for forming the photosensitive layer comprises a charge generating material, a charge transporting material, a binder, and a solvent that can dissolve the electron transporting material layer.

10. The organic photoreceptor of claim 6, wherein the solution for forming the photosensitive layer is coated by a method selected from the group consisting of a ring coating method, a spray coating method, and a roll coating method.

11. An image forming apparatus comprising an organic photoreceptor of claim 1.

12. An electrophotographic cartridge comprising:
an organic photoreceptor of claim 1;
a charging device to charge the electrophotographic photoreceptor;
a developing device to develop an electrostatic latent image formed on the electrophotographic photoreceptor; and
a cleaning device to clean a surface of the electrophotographic photoreceptor,
the electrophotographic cartridge being attachable to or detachable from an imaging apparatus.

13. An electrophotographic drum comprising an organic photoreceptor of claim 1, the electrophotographic drum being attachable to or detachable from an imaging apparatus.

14. An image forming apparatus comprising:
a photoreceptor unit comprising an organic photoreceptor of claim 1;
a charging device to charge the photoreceptor unit;
an imagewise light irradiating device to irradiate light onto the charged photoreceptor unit to form an electrostatic latent image on the photoreceptor unit;
a developing unit to develop the electrostatic latent image with a toner to form a toner image on the photoreceptor unit; and
a transfer device to transfer the toner image onto a receptor.

15. A method of manufacturing an organic photoreceptor, the method comprising:
forming an electron transporting material layer by coating an electron transporting material on an electrically conductive substrate; and
forming a photosensitive layer by coating a solution for forming a photosensitive layer on the electron transporting material layer.

16. A method of manufacturing an organic photoreceptor, the method comprising:
forming a layer containing an electron transporting material by coating an electron transporting material dispersed by a binder on an electrically conductive substrate; and
forming a photosensitive layer by coating a solution for forming a photosensitive layer on the electron transporting material layer.

17. The method of claim 15, wherein a thickness of the electron transporting material layer or the layer containing the electron transporting material is 0.01 to 1 μm.

18. The method of claim 15, wherein the solution for forming a photosensitive layer comprises a solvent that can dissolve a charge generating material, a charge transporting material, a binder, and the electron transporting material layer, whereby the electron transporting material migrates through the photosensitive layer to form a photosensitive layer having an increasing concentration of the electron transporting material toward an interface between the electrically conductive substrate and the photosensitive layer.

19. The method of claim 15, wherein the solution for forming the photosensitive layer is coated by a method selected from the group consisting of a ring coating method, a spray coating method, and a roll coating method.

20. The organic photoreceptor of claim 16, wherein the content of the electron trasporting material in the electron transporting material layer is 30 weight % or greater.

21. The method of claim 16, wherein a thickness of the electron transporting material layer or the layer containing the electron transporting material is 0.01 to 1 μm.

22. The method of claim 16, wherein the solution for forming a photosensitive layer comprises a solvent that can dissolve a charge generating material, a charge transporting marterial, a binder, and the electron transporting material layer, whereby the electron transporting material migrates through the photosensitive layer to form a photosensitive layer having an increasing concentration of the electron transporting material toward an interface between the electrically conductive substrate and the photosensitive layer.

23. The method of claim 16, wherein the solution for forming the photosensitive layer is coated by a method selected from the group consisting of a ring coating method, a spray coating method, and a roll coating method.
